(19) United States
(12) Patent Application Publication
(10) Pub. No.: US 2003/0079692 A1
(43) Pub. Date: May 1, 2003

(54) Liquid feeding nipple having two-stage trigger pin

(75) Inventors: Frederick W. Steudler JR., Conestoge, PA (US); Daniel B. Trong, Lancaster, PA (US)

Correspondence Address: BRUCE H. TROXELL, 5205 LEESBURG PIKE, SUITE 1404, FALLS CHURCH, VA, 22041, US

(73) Assignee: VAL PRODUCTS, INC.

(21) Appl. No.: 09/983,621

(22) Filed: Oct. 25, 2001

(51) Int. Cl. A01K 7/00

(52) U.S. Cl. 119/72.5

(57) ABSTRACT

A liquid feeding nipple is disclosed for feeding liquids to fowl having a hollow housing, a valve seat insert located in the housing, the valve seat insert having a first liquid passage, a housing cap on a second end of the housing, the housing cap having a second liquid passage, and a valve member movably located within the housing so as to be movable between a closed position, in which liquid communication between the first and second liquid passages is prevented, and an open position which enables liquid communication between the first and second liquid passages. The liquid feeding nipple also has a trigger pin with a head in contact with the valve member and a stem extending from the housing. The stem has a first flow control portion adjacent to the head and a second flow control portion adjacent to the first flow control portion such that the cross-sectional area of the second flow control portion is less than that of the first flow control portion. As the younger chicks contact the distal end of the trigger pin extending below the nipple housing at the aforementioned angle of between 30 degrees and 45 degrees, the trigger pin will be displaced such that the valve member is opened and the first flow control portion controls the amount of liquid flowing out of the nipple. As the size of the bird increases, the angle at which the trigger pin is contacted also increases, such contact causing increasing displacement of the trigger pin in a vertical direction. Such displacement of the trigger pin enables the second flow control portion to assume control of the amount of liquid passing through the nipple. Since the cross-sectional area of the second flow control portion is less than that of the first flow control portion, a greater amount of liquid may flow from the nipple.

### BACKGROUND OF THE INVENTION

The present invention relates to a liquid feeding nipple for feeding liquids to fowl, such as chickens and turkeys, more specifically such a feeding nipple having a two-stage trigger pin. The two-stage trigger pin controls the flow of liquid through the nipple to provide the proper amount of liquid as the fowl grows.

Liquid feeding nipples for feeding liquids to chickens and turkeys are well known in the art and typically have a valve that is actuated by a trigger pin. The valve is normally in a closed position to prevent liquid from leaking out of the nipple and is opened by the action of the fowl pecking at the portion of the trigger pin extending from the nipple housing. Suck pecking action displaces the trigger pin and valve element, enabling liquid to flow through the nipple.

Quite obviously, the amount of liquid required by a young chick is less than that required by a more mature bird. As illustrated in FIG. 1A, a young chick reaches the trigger pin of the nipple 10 at an angle of between 30 degrees and 45 degrees. As the bird matures, the liquid system is progressively raised such that a mature bird will contact the trigger pin at an angle of between 70 degrees and 80 degrees, as illustrated in FIG. 1B. While there are known methods of controlling the liquid flow through the nipple to accommodate the various sizes of fowl, all such known systems utilize a single stage trigger pin having a cylindrical stem extending from the nipple.

### SUMMARY OF THE INVENTION

A liquid feeding nipple is disclosed for feeding liquids to fowl having a hollow housing, a valve seat insert located in the housing, the valve seat insert having a first liquid passage, a housing cap on a second end of the housing, the housing cap having a second liquid passage, and a valve member movably located within the housing so as to be movable between a closed position, in which liquid communication between the first and second liquid passages is prevented, and an open position which enables liquid communication between the first and second liquid passages. The liquid feeding nipple also has a trigger pin with a head in contact with the valve member and a stem extending from the housing. The stem has a first flow control portion adjacent to the head and a second flow control portion adjacent to the first flow control portion such that the cross-sectional area of the second flow control portion is less than that of the first flow control portion. As the younger chicks contact the distal end of the trigger pin extending below the nipple housing at the aforementioned angle of between 30 degrees and 45 degrees, the trigger pin will be displaced such that the valve member is opened and the first flow control portion controls the amount of liquid flowing out of the nipple. As the size of the bird increases, the angle at which the trigger pin is contacted also increases, such contact causing increasing displacement of the trigger pin in a vertical direction. Such displacement of the trigger pin enables the second flow control portion to assume control of the amount of liquid passing through the nipple. Since the cross-sectional area of the second flow control portion is less than that of the first flow control portion, a greater amount of liquid may flow from the nipple.

The first and second flow control portions of the trigger pin according to this invention have cylindrical configurations with smooth outer surfaces, wherein the diameter of the first flow control portion is greater than that of the second flow control portion, and the axial length of the first flow control portion is less than the axial length of the second flow control portion. The distal end portion also has a cylindrical configuration with a smooth outer surface, the diameter of the distal end portion being greater than that of the second flow control portion.

The invention also encompasses a liquid feeding system incorporating a plurality of nozzles affixed to a liquid supply pipe which, in turn, is connected to a source of liquid through a pressure regulator to prevent excess pressures within the supply pipe.

### BRIEF DESCRIPTION OF THE DRAWINGS

FIG. 1A is a pictorial representation of a young chick utilizing the nozzle according to the present invention.

FIG. 1B is a pictorial representation of a mature bird using the nipple according to the present invention.

FIG. 2 is a perspective view of the liquid feeding nipple according to the present invention.

FIG. 3 is a cross-sectional view of the liquid feeding nipple according to the present invention with the valve member in the closed position.

FIG. 4 is a side view of the trigger pin according to the present invention.

FIG. 5 is a cross-sectional view, similar to FIG. 3, but showing the trigger pin displaced such that the first flow control portion controls liquid flow through the nipple.

FIG. 6 is a cross-sectional view, similar to FIG. 3, but illustrating the valve member in an open position and the trigger pin displaced such that the second flow control portion controls liquid flow through the nipple.

FIG. 7 is a perspective view of a liquid feeding system incorporating the nozzles according to the present invention.

FIG. 8 is a cross-sectional view of an embodiment of the present invention not using a metering pin.

### DETAILED DESCRIPTION OF THE PREFERRED EMBODIMENTS

In reference to FIGS. 2-4, the liquid feeding nipple 10 comprises a hollow housing 12 having an opening 14 extending through first and second opposite ends thereof, and a valve seat insert 16 located within the housing 12 adjacent to a first end thereof. While the hollow housing 12 may be made of a plastic material, the valve seat insert 16 is preferably made of a metallic material and has valve seats 16a and 16b on an upper portion thereof. Although it is well known in the art to utilize such a valve insert with a plurality of valve seats, it is to be understood that valve seat insert 16 may also include only a single valve seat. Valve seat insert 16 also defines a first liquid passage 18 having a generally conical configuration with the passage becoming wider in a direction towards the external end of the valve seat insert 16 which is adjacent to the first end of the hollow housing 12. Hollow housing 12 may also include a hook member 20 extending from one side thereof to facilitate attachment of the nipple to the liquid supply pipe.

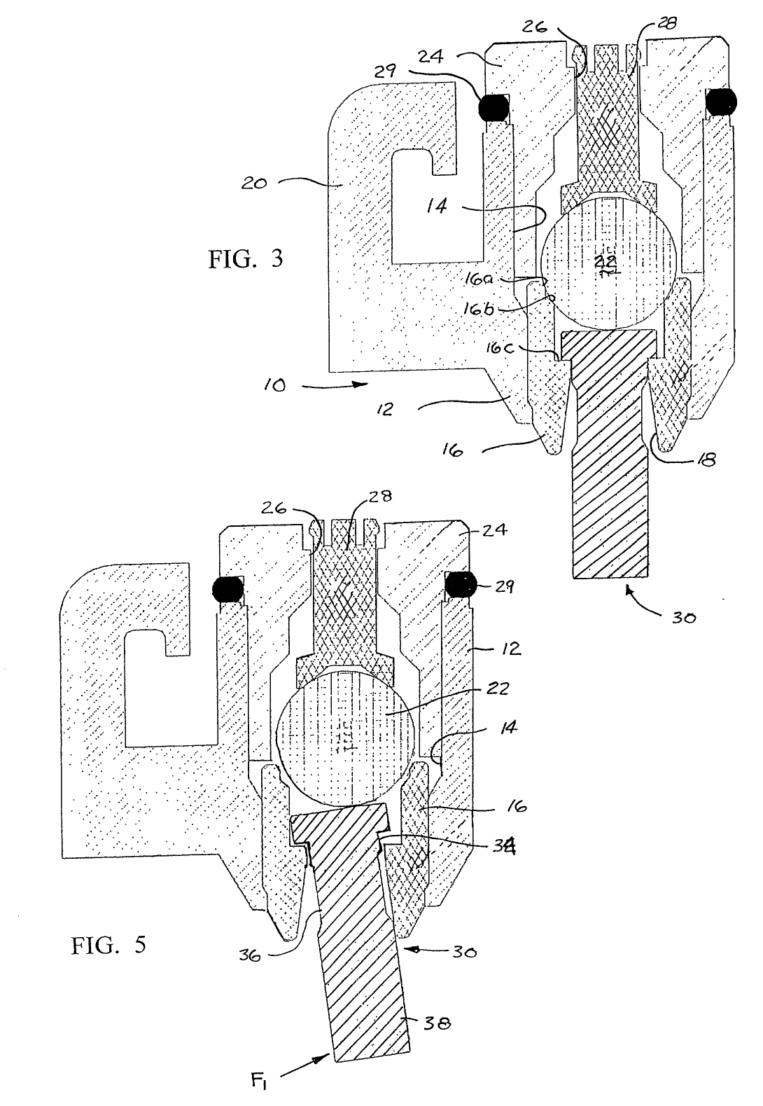

A valve member 22 is movably located within the opening 14 of housing 12 so as to be movable between closed and open positions. Although the invention will be described with the valve member comprising a ball valve, it is to be understood that other types of valve members may be utilized with the present invention. In the closed position illustrated in FIG. 3, the valve member 22 contacts valve seats 16a and 16b. Also attached to housing 12 is housing cap 24 located at the second end of the housing 12, the housing cap 24 having a second liquid passage 26 therein. In known fashion, the second liquid passage 26 communicates with the interior of a liquid supply pipe when the feeding nipple 10 is attached thereto, thereby enabling liquid to flow through the second liquid passage 26 into the opening 14 within the housing 12. However, when the valve member 22 is in the closed position, liquid is prevented from entering and passing through the first liquid passage 18.

A metering pin 28 may extend through the second liquid passage 26 so as to control the amount of liquid entering the housing 12 through the second liquid passage 26. Such metering pins 28 are well known in the art and may be configured to control the passage of liquid through second liquid passage 26. Metering pin 28 rests on valve member 22 and is moved along with the valve member 22. O-ring 30 may be utilized between housing cap 24 and hollow housing 12 to prevent leakage of fluid at their juncture.

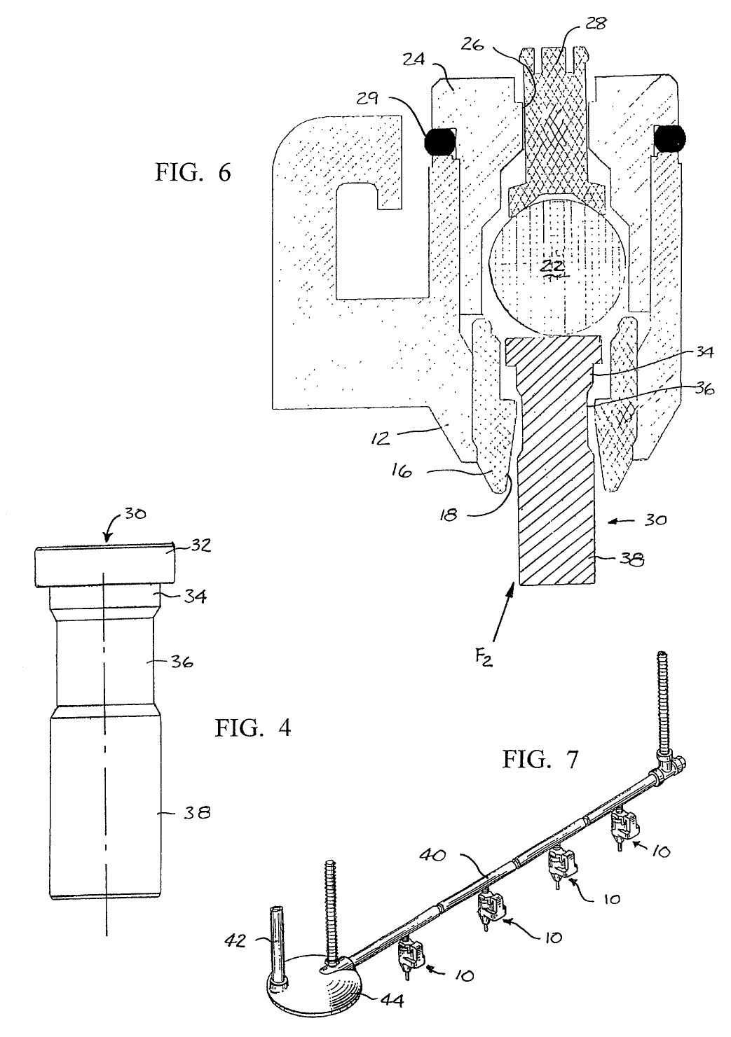

The trigger pin 30 according to the present invention is best seen in Applicant's FIGS. 3 and 4. The two-stage trigger pin 30 comprises a head 32 having an upper surface which contacts the valve member 22, as best seen in FIG. 3, a first flow control portion 34, a second flow portion 36 and a distal end portion 38. The various portions of the trigger pin 30 are cylindrical in configuration about longitudinal axis 40 and the first flow control portion 34, the second flow control portion 36 and the distal end portion 38 all have smooth outer surfaces. A cross-sectional area of first flow control portion 34 is greater than the cross-sectional area of second flow control portion 36. In a cylindrical configuration, this is achieved by having the diameter of first flow control portion 34 greater than the diameter of flow control portion 36. Similarly, the cross-sectional area and the diameter of distal end portion 38 is greater than the cross-sectional area and the diameter of second flow control portion 36. Preferably the two-stage trigger pin 30 is formed of a metallic material, such as stainless steel. It has been found that the configuration of the trigger pin 30 results in less contact between the surface of the trigger pin and the surface of the first liquid passage 18, thereby resulting in an increased life span for the trigger pin.

As best seen in FIG. 3, the two-stage trigger pin 30 is located in the valve seat insert 16 such that a lower surface of the head 32 rests against valve seat 16c while the upper surface of head 32 supports the valve member 22. Although not illustrated, it is well known in the art to provide a concave indentation in the upper surface of head 32 to accommodate a portion of the valve member 22 therein. Thus, in the valve closed position, liquid is prevented from entering the first liquid passage 18 by the contact between the valve member 22 and the valve seats 16a and 16b, as well as by contact between the head 32 and the valve seat 16c.

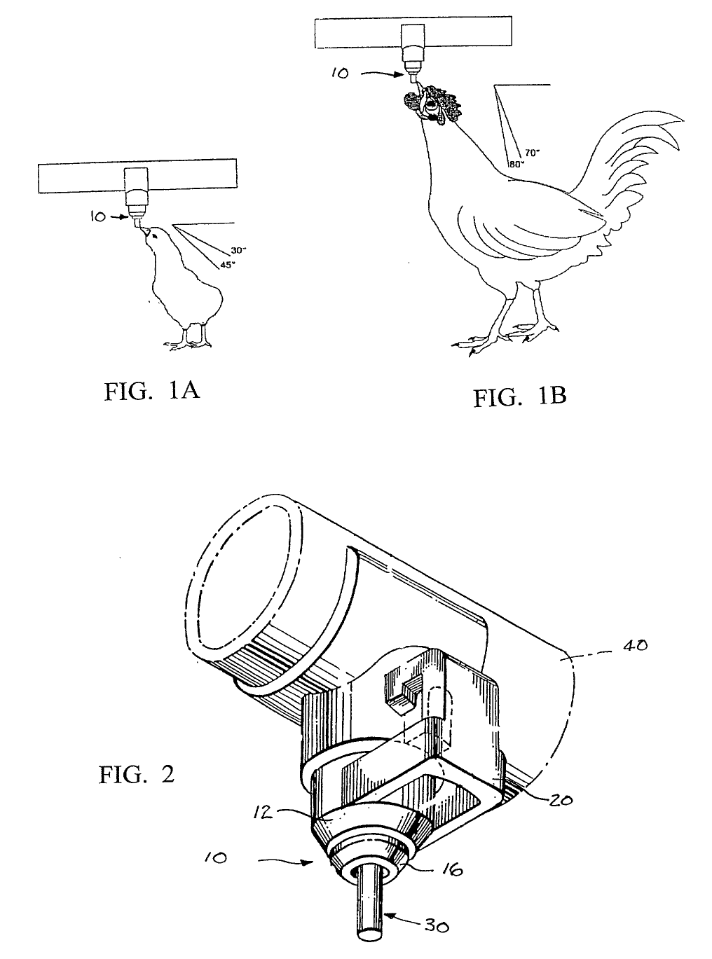

When the liquid feeding nipple is used by younger birds, such as the chick shown in FIG. 1A, the trigger pin 30 will be displaced as illustrated in Applicant's FIG. 5 by force F applied by the bird. Such force F₁ will slightly elevate and tilt the trigger pin 30 so as to displace the valve member 22 away from valve seats 16a and 16b thereby enabling the liquid to pass into the first liquid passage 18. The space between the first liquid control portion 34 and the wall bounding the first liquid passage 18 will determine the amount of liquid passing through the nipple 10.

When the nipple is used to supply liquid to a mature bird, as illustrated in FIGS. 1B and 6, the mature bird exerts a force on the two-stage trigger pin 30 in a more vertical direction, as illustrated in FIG. 6 at F₂. Force F₂ raises the trigger pin 30 in a more vertical direction than does force F₁ such that the second flow control portion 36 controls the flow of liquid through the first liquid passage 18. Since the cross-sectional area in diameter of second flow control portion 36 is less than the cross-sectional area in diameter of first flow control portion 34, a greater amount of liquid will flow through the first liquid passage 18. This assures an adequate supply of liquid to the mature bird. The generally conical configuration of the first liquid passage 18 accommodates the tilting and lifting displacement of the trigger pin 30.

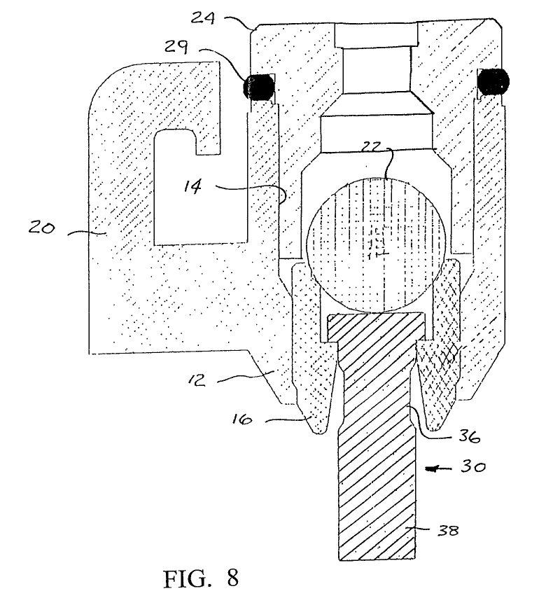

A liquid feeding system utilizing the liquid feeding nipple according to the present invention is illustrated in FIG. 7. In this system, a plurality of feeding nipples 10 are spaced apart along a length of liquid supply pipe 40 attached to a source of liquid 42 through a pressure regulator 44. The source of liquid 42 may comprise a stand pipe, or a pressurized source of liquid. The pressure regulator 44 reduces the pressure of the liquid within the liquid supply pipe 40 to prevent an excess amount of water from exiting through the liquid feeding nipples upon displacement of the trigger pin 30.

FIG. 8 discloses an alternative embodiment of Applicant's invention in which the liquid feeding nipple does not utilize the metering pin. Otherwise, the construction of the housing, the housing cap 24, the valve seat insert 16, the valve member 22 and the two-stage triggering pin 30 are identical to the previously described embodiment.

The foregoing description is provided for illustrative purposes only and should not be construed as in any way limiting this invention, the scope of which is defined solely by the appended claims.

What is claimed is:

1. A liquid feeding nipple for feeding liquid to fowl and comprising:
a) a hollow housing having an opening extending through first and second opposite ends thereof;
b) a valve seat insert located in the housing adjacent to a first end thereof, the valve seat insert having a first liquid passage and at least one valve seat;
c) a housing cap on the housing at a second end thereof, the housing cap having a second liquid passage;
d) a valve member movably located within the housing so as to be movable between a closed position in which the valve member contacts the at least one valve seat so as to prevent liquid communication between the first and second liquid passages, and an open position in which the valve member is displaced out of contact with the at least one valve seat thereby enabling liquid communication between the first and second liquid passages; and,
e) a trigger pin having a head in contact with the valve member and a stem extending from the head, the stem having: a first flow control portion adjacent to the head with a first transverse cross-sectional area; a second flow control portion adjacent to the first flow control portion, the second flow control portion having a second transverse cross-sectional area smaller than the first transverse cross-sectional area; and a distal end portion extending exteriorly of the housing, whereby movement of the triggering pin moves the valve member between the open and closed positions.

2. The liquid feeding nipple of claim 1 further comprising a metering pin in contact with the valve member and extending through the second liquid passage.

3. The liquid feeding nipple of claim 1 wherein an axial length of the first flow control portion is less than an axial length of the second flow control portion.

4. The liquid feeding nipple of claim 1 wherein the first and second flow control portions are located in the first liquid passage.

5. The liquid feeding nipple of claim 1 wherein the first and second flow control portions have circular cross-sectional configurations.

6. The liquid feeding nipple of claim 1 wherein the first liquid passage has a generally conical configuration such that the transverse dimension increases in a direction toward the first end of the housing.

7. The liquid feeding nipple of claim 1 further comprising a hook member extending from one side of the housing.

8. A liquid feeding system for feeding a liquid to a fowl and comprising:
a) a liquid supply pipe connected to a source of liquid; and,
b) at least one liquid feeding nipple attached to the liquid supply pipe, the at least one nipple comprising:
i) a hollow housing having an opening extending through first and second opposite ends thereof;
ii) a valve seat insert located in the housing adjacent to a first end thereof, the valve seat insert having a first liquid passage and at least one valve seat;
iii) a housing cap on the housing at a second end thereof, the housing cap having a second liquid passage;
iv) a valve member movably located within the housing so as to be movable between a closed position in which the valve member contacts the at least one valve seat so as to prevent liquid communication between the first and second liquid passages, and an open position in which the valve member is displaced out of contact with the at least one valve seat thereby enabling liquid communication between the first and second liquid passages; and,
v) a trigger pin having a head in contact with the valve member and a stem extending from the head, the stem having: a first flow control portion adjacent to the head with a first transverse cross-sectional area; a second flow control portion adjacent to the first flow control portion, the second flow control portion having a second transverse cross-sectional area smaller than the first transverse cross-sectional area; and a distal end portion extending exteriorly of the housing, whereby movement of the triggering pin moves the valve member between the open and closed positions.

9. The liquid feeding system of claim 8 wherein the source of water comprises a standpipe.

10. The liquid feeding system of claim 8 further comprising a pressure regulator between the liquid supply pipe and the source of liquid.

11. The liquid feeding system of claim 8 further comprising a plurality of liquid feeding nipples spaced apart along a length of the liquid supply pipe.

12. The liquid feeding system of claim 8 wherein the at least one liquid feeding nipple further comprises a metering pin in contact with the valve member and extending through the second liquid passage.

13. The liquid feeding system of claim 8 wherein an axial length of the first flow control portion of the trigger pin is less than an axial length of the second flow control portion.

14. The liquid feeding system of claim 8 wherein the first and second flow control portions of the trigger pin are located in the first liquid passage.

15. The liquid feeding system of claim 8 wherein the first and second flow control portions of the trigger pin have circular cross-sectional configurations.

16. The liquid feeding system of claim 8 wherein the first liquid passage of the at least one liquid feeding nipple has a generally conical configuration such that the transverse dimension increases in a direction toward the first end of the housing.

17. The liquid feeding system of claim 8 wherein the at least one liquid feeding nipple further comprises a hook member extending from one side of the housing.
